(19) United States
(12) Patent Application Publication
(10) Pub. No.: US 2001/0009635 A1
(43) Pub. Date: Jul. 26, 2001

(54) Method for manufacturing a paving stone and a paving stone

(76) Inventor: Stefan Aurelius, Burgsvik (SE)

Correspondence Address: YOUNG & THOMPSON, 745 SOUTH 23RD STREET 2ND FLOOR, ARLINGTON, VA, 22202

(21) Appl. No.: 09/768,278

(22) Filed: Jan. 25, 2001

(30) Foreign Application Priority Data
Jan. 25, 2000 (SE) 0000199-0

(51) Int. Cl. E01C 5/22; B22D 25/06; B29C 39/10

(52) U.S. Cl. 404/44; 264/250; 264/274; 29/527.5; 164/76.1

(57) ABSTRACT

The present invention relates to a method for manufacturing a paving stone. The invention also relates to a paving stone.

Significant for the method according to the present invention is that in a first step a first mould (1, 3) is set up, said mould (1, 3) having an internal space for casting a first portion (18) of the paving stone, said first portion (18) constituting a metal alloy, and that in a second step the metal alloy, in liquid state, is supplied to the space inside the first mould, that in connection with casting of the first portion (18) anchoring means, in the shape of elongated elements (22), are attached to said first portion (18), said elongated elements (22) having a general extension transverse to the main plane of the first portion (18), and that in a third step, in a second mould, the first portion (18) is cast integral with a volume of concrete that in hardened state forms a second portion (23) of the paving stone on the side of the first portion (18) where the anchoring means are located, said second portion constituting a concrete block (23).

### TECHNICAL FIELD OF THE INVENTION

The present invention relates to a method for manufacturing a paving stone. The invention also relates to a paving stone that preferably is manufactured in accordance with said method.

### PRIOR ART

From JP 7207609 a paving stone is previously known, said paving stone including a plate of stainless steel. Projecting anchoring means are provided on one side of said plate, said anchoring means being intended to be embedded in a concrete block that together with the plate constitute a paving stone.

From U.S. Pat. No. 3,950,908 a panel for covering of walls or floors is previously known. Said panel includes a stiff, planar load-bearing element having a resilient, covering element that is mounted to the load-bearing element. In connection therewith the resilient covering element is provided with anchoring means that are received in recesses in the stiff, planar load-bearing element. The anchoring means are fixed in the recesses by means of a hardenable adhesive. Preferably the resilient, covering element constitutes rubber.

### OBJECTS AND FEATURES OF THE INVENTION

A primary object of the present invention is to present a method for manufacturing a paving stone, said method being carried out, preferably on handicraft basis, by means of extremely simple and cheap resources.

A further object of the present invention is that the method results in a product, i.e. a paving stone, that has a satisfactory function in combination with an extremely inviting appearance and a comparatively low price.

Still an object of the invention is that in connection with manufacturing of a paving stone according to the present invention its dimensions may vary in a relatively simple way.

At least the primary object of the present invention is realised by means of a method and a paving stone that have been given the features of the appending independent claims. Preferred embodiments of the invention are defined in the independent claims.

### BRIEF DESCRIPTION OF THE DRAWINGS

Below an embodiment of the invention will be described, reference being made to the accompanying drawings, where:

FIG. 1 shows a section through two mould halves of foundry sand, said halves between themselves receiving a prototype;

FIG. 2 shows a section through a male-shaped mould half, in which cavities are provided by means of a nail or the like, said cavities being shown by dotted lines since they are not located in the section;

FIG. 3 shows a perspective view of the male-shaped mould half according to FIG. 2;

FIG. 4 shows a perspective view of a female-shaped mould half;

FIG. 5 shows a perspective view of the upper side of the metal alloy portion of the paving stone according to the present invention;

FIG. 6 shows a perspective view of the lower side of the metal alloy portion of the paving stone according to the present invention; and

FIG. 7 shows schematically a perspective view of a complete paving stone according to the present invention, where a portion of the paving stone, for reasons of clarity, has been made transparent.

### DETAILED DESCRIPTION OF A PREFERRED EMBODIMENT OF THE METHOD

### AND DEVICE ACCORDING TO THE PRESENT INVENTION

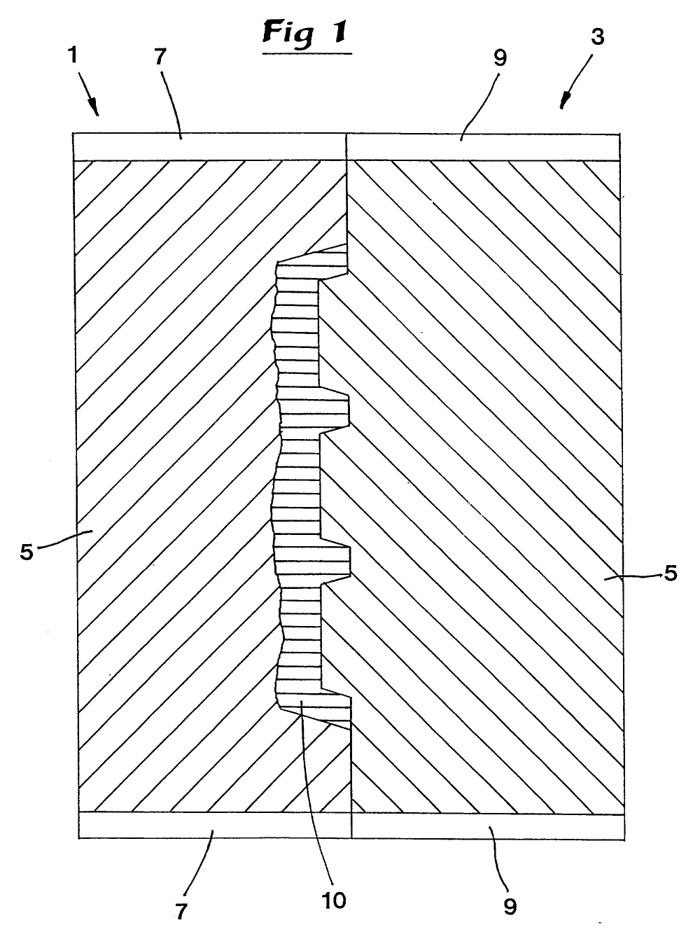

In FIG. 1 it is shown how two mould halves 1 and 3 of foundry sand have been brought into abutment with each other. Each of the mould halves 1, 3 is manufactured from so-called foundry sand 5, that is received inside a frame 7, 9 of the respective mould half 1 and 3. The foundry sand 5 is given a suitable humidity in connection with the forming of said foundry sand. This makes the foundry sand 5 easy to form and stable, i.e. it maintains the impression in respective mould half 1, 3 that is provided by means of a prototype 10 that is inserted between the mould halves 1 and 3 when said mould halves 1, 3 are built up around the prototype 10 in the way shown in FIG. 1. When the prototype 10 has made the necessary impressions in the foundry sand 5 in respective mould half 1, 3 they are separated from each other in connection with the removal of the prototype 10.

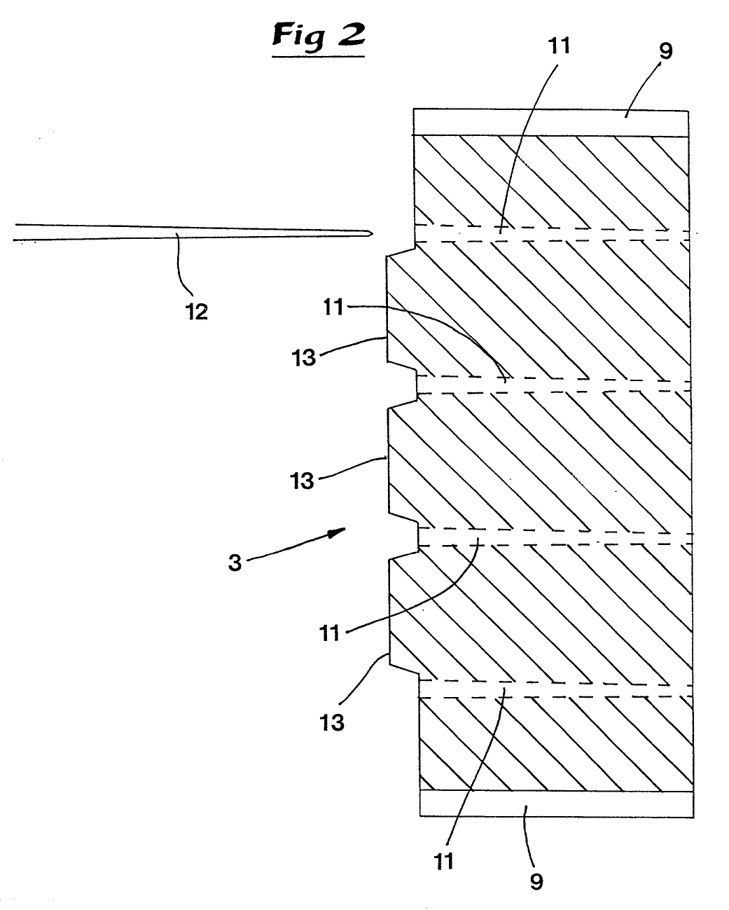

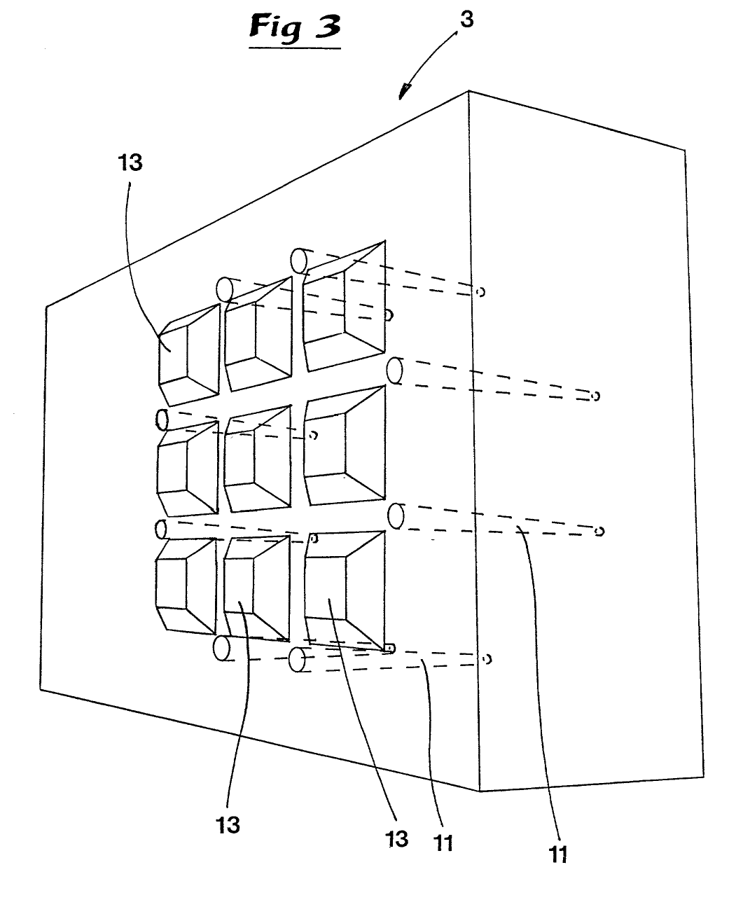

As is shown in FIG. 2 a certain working of the male-shaped mould half 3 takes place, said working being that the male-shaped mould half 3 is provided with a number of cavities 11, that in the shown embodiment constitute passages 11 for forming and aeration, said passages 11 extending transverse to the main plane of the surface of the male-shaped mould half 3 that is equipped with an impression. The passages 11 for forming and aeration are preferably created by means of a steel nail 12 or the like. As is shown in FIG. 2 the passages 11 for forming and aeration extend through the male-shaped mould half 3, i.e. they have a length corresponding to the thickness of the male-shaped portion 3. From FIG. 3 it is also evident that the steel nail 12 is slightly conical in the shown embodiment, which means that also the created passages 11 for forming and aeration have a corresponding slightly conical shape. Said conical shape facilitates the relief between the steel nail 12 and the foundry sand when the steel nail 12 is extracted from the foundry sand subsequent to the creation of a passage 11 for forming and aeration.

In FIG. 3 a perspective view of the male-shaped mould half 3 is shown, whereby it is evident from said perspective view that the mould half 3 is equipped with a number, in the disclosed embodiment nine, projecting male portions 13. These male portions 13 thus constitute an impression of the right side of the prototype 10 in FIG. 1. As is evident from FIG. 3 the male portions 13 is in the shape of truncated four sided cones, this shape being preferred as regards the creation of relief relative to the prototype 10 in connection with its removal. The projecting male portions 13 are internally arranged in a regular pattern such that they are located inside an imaginary square frame. Also the passages 11 for forming and aeration are shown in FIG. 3, said passages 11 being created in the male-shaped mould half 3. Thereby, it is evident that said passages 11 for forming and aeration have their inlet openings adjacent to the imaginary square frame that surrounds the projecting male portions 13.

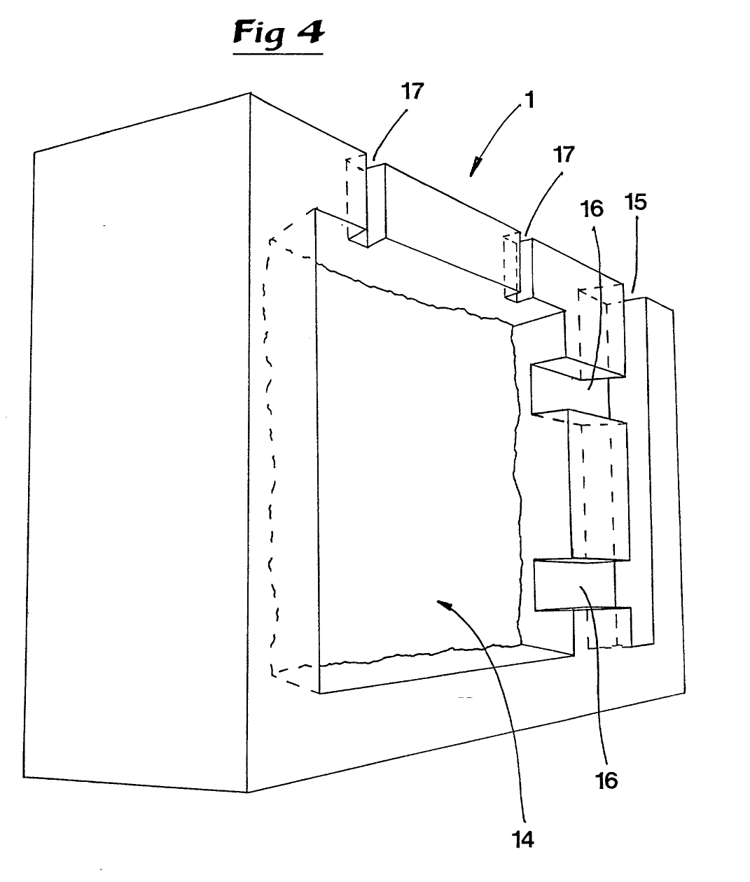

In FIG. 4 a perspective view of the female-shaped mould half 1 is shown, whereby it is evident from said perspective view that the prototype 10 has created an integral female portion 14 that generally constitutes a recess, whose outer contour is square and corresponds to the imaginary square frame that surrounds the projecting male portions 13, see FIG. 3. The bottom surface of the recess 14 is rough and thus constitutes an impression of the rough side of the prototype 10, i.e. the left side in FIG. 1.

The female-shaped mould half 1 according to FIG. 4 also has a casting passage 15 that has a generally vertical extension in FIG. 4. Two generally horizontal branch casting passages 16 in FIG. 4 connect the casting passage 15 to the recess 14. The female-shaped mould half 1 has also two aeration passages 17 that generally have a vertical extension in FIG. 4, said aeration passages extending between the recess 14 and the outside of the female-shaped mould half 1.

In this connection it should be pointed out that for reasons of clarity the frames 7 and 9 around the mould halves 1 and 3 respectively have been omitted in FIGS. 3 and 4.

In connection with the method to manufacture a paving stone according to the present invention the portion constituting a metal alloy, preferably a copper-base alloy, especially bronze, is cast in a first step. Said portion constitutes, when the paving stone is in working position, the upwards facing wearing part. The actual casting takes place in the space that is created between the female-shaped mould half 1 and the male-shaped mould half 3, when these mould halves 1, 3 are assembled in the way that is shown in FIG. 1. Then the metal alloy is supplied, in liquid state, to the recess 14 via the casting passage 15 and the branch casting passages 16. In case the metal alloy constitutes bronze the temperature of the metal alloy, in this phase, normally is in the interval 1200-1300° C. The liquid metal alloy will fill out the recess 14 and also surround the projecting male portions 13. The provision of two branch casting passages 16 means that in an initial phase of casting the liquid metal alloy will flow into the space between the mould halves 1 and 3 via the lower branch casting passage 16, said liquid metal alloy will fill out the lower portion of the space between the mould halves 1 and 3 while the upper surface of said liquid metal alloy will rise upwards in said space. The larger volume liquid metal alloy that flows into the space between the mould halves 1 and 3 the larger resistance will be exerted against the supply of further liquid metal alloy via the lower branch casting passage 16. In this connection it is preferable with still a further, higher-up branch casting passage 16, through which the liquid metal alloy may flow into the space between the mould halves 1 and 3 during the later phase of the casting. The air, displaced by the liquid metal alloy, will to a major part exhaust through the aeration passages 17.

The liquid metal alloy will also flow out into the passages 11 for forming and aeration, and the displaced air will flow out through said passages 11 for forming and aeration since they are through going, i.e. they emerge on the side of the male-shaped mould half that is facing away from the projecting male portions 13. However, liquid metal alloy will normally not flow through the passages 11 for forming and aeration, this probably depending on that said passages are slightly conical and that the liquid metal alloy has a certain surface tension, said liquid metal alloy being rapidly cooled when flowing out into the passages 11 for forming and aeration. When the space between the mould halves 1 and 3 and the passages 11 for forming and aeration are completely filled by the liquid metal alloy this is indicated in that liquid metal alloy also rises up in the aeration passages 17.

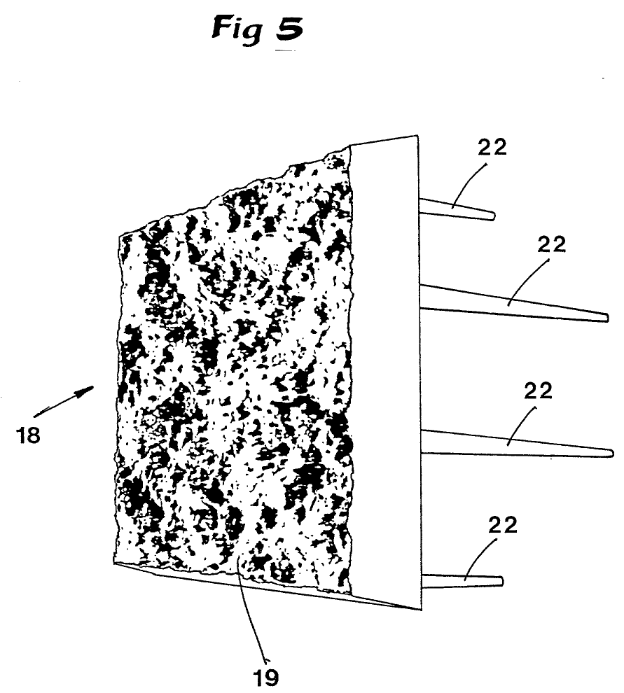

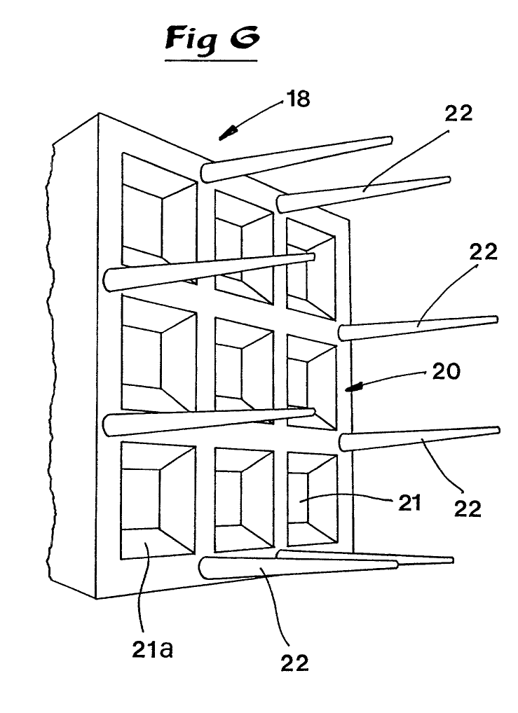

The metal alloy in the space between the mould halves 1 and 3 is now allowed to harden during a certain time, this normally being for about 24 hours. Then the mould halves 1 and 3 are stripped and the portion constituting a metal alloy is exposed. Such a portion 18, constituting a metal alloy, is shown in FIGS. 5 and 6. The rough surface 19 of the portion 18 is evident from FIG. 5, said rough surface 19 constituting the upwards facing wear resistant side surface of the completed paving stone.

As is evident from FIG. 6 the portion 18 has a number of recesses 21 on the side 20 that faces away from the rough surface, said recesses 21 having a shape that is complementary to the shape of the male portions 13 of the male-shaped mould half 3, i.e. the recesses 21 are in the shape of truncated cones having four sides. The portion 18, constituting a metal alloy, has also a number of conical pins 22 that also constitute hardened metal alloy, i.e. they are cast integral with said portion 18. In the shown embodiment the pins 22 are located along the edges of the portion 18 that constitutes a metal alloy, and more precisely said pins 22 are located on a central portion of said longitudinal edges, i.e. there are no pins 22 in the corner areas of the portion 18 constituting a metal alloy.

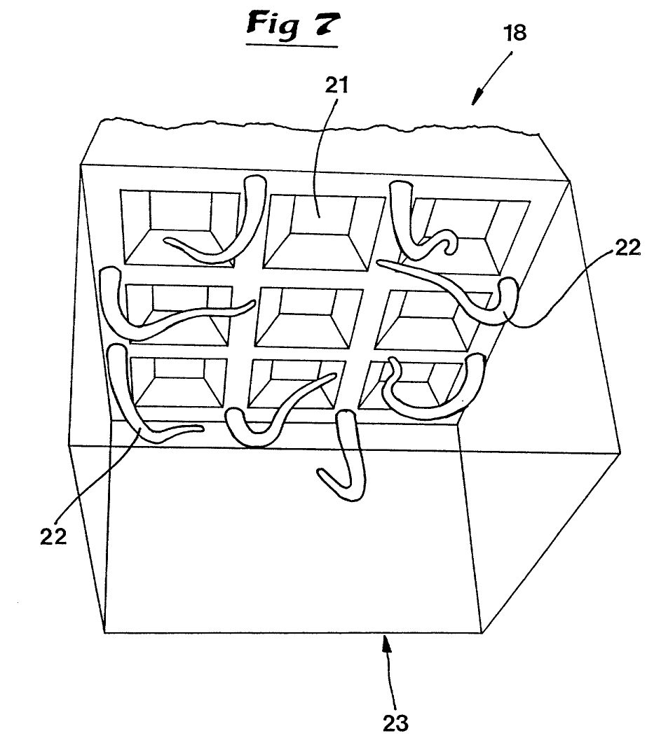

The portion 18, constituting a metal alloy, is thereby finished. In order to create a paving stone according to the present invention said portion 18 is to be cast integral with a concrete block 23, see FIG. 7. Before the assembling casting takes place the pins 22 are preferably bent in order to make them curved, which provides an improved cooperation with the concrete that the portion 18 is cast integral with. In connection with the assembling casting the portion 18, constituting a metal alloy, is located in a mould, e.g. in the shape of a bowl, having the corresponding internal contour as the outer contour of the portion 18. The portion 18 is oriented in such a way that the rough surface abuts the bottom of the mould. Concrete in liquid state is now poured into the bowl, whose dimensions are adapted in such a way that when concrete has been filled up to a certain level in the bowl a volume of concrete has been created on top of the portion 18 constituting a metal alloy, said volume in hardened condition creating the concrete block 23 that is shown in FIG. 7. The liquid concrete will fill out the recesses 21 that are provided on the side of the portion 18, constituting a metal alloy, that faces towards the concrete. Thereby, an enlarged adhesion surface is created for the concrete compared to if the side facing towards the concrete is planar. This means that the concrete, after hardening, creates an excellent stability for the portion 18 constituting a metal alloy. Since the adhesion surface for the concrete comprises recesses 21 a number of surfaces 21a are created in connection with each recess 21. The surfaces 21a of each recess 21 define together a truncated cone having four sides. Since said surfaces 21a form non-perpendicular angles with the main plane of the first portion 18 the dynamic forces, generated by the traffic, that act on the paving stone according to the present invention will in principle always be carried by a surface that runs transverse to said forces. Thereby, these forces may be absorbed in a satisfying way.

As pointed out above the curved shape of the pins 22 brings about that the adhesion relative to the concrete is good, i.e. the joint between the concrete and the portion 18 constituting a metal alloy will normally handle the stresses that the paving stone is subjected to. As a non-limiting example it may be mentioned that a preferred dimension of the paving stone according to the present invention is a side length of 10 cm, which of course is pertinent both for the portion 18, constituting a metal alloy, and the concrete block 23. The paving stone is generally square in top view in its working position. As a non-limiting example it may be mentioned that the portion 18, constituting a metal alloy, may have a thickness in side view of 13 mm and in its most thin portion a thickness of 5-6 mm. The concrete block 23 may have a thickness of 6-10 cm.

Since the paving stone according to the present invention has only a comparatively thin plate 18 of a metal alloy and the rest of the paving stone constitutes a concrete block 23 the cost for said paving stone is comparatively low in relation to the visual impression of the paving stone when it is in working position, i.e. when it is positioned as for instance pavement surfacing. Since it is relatively simple to change the dimensions of the paving stone according to the present invention, said paving stone may be adapted to other paving stones in the market and the paving stone according to the present invention may be laid together with other, preferably cheaper paving stones.

Generally, it may be mentioned that the use of a metal alloy, preferably bronze, as wear material of a paving stone gives rise to special architectural effects. Since the bronze is permanently subjected to verdigris from the climate but also permanently is polished by the feet of the pedestrians it is possible by ocular inspection to learn where people walk and not walk on the stone pavement area. The more frequented routes receive a more polished surface while the less frequented routes have paving stones where the bronze is subjected to verdigris without the polishing from the feet of the pedestrians.

### Feasible Modifications of the Invention

In accordance with the embodiment described above the pins 22 are created by having the liquid metal alloy flowing out in the passages 11 for forming and aeration in the male-shaped mould half 3. However, it is feasible within the scope of the present invention to have the pins in the shape of remaining steel nails that are mounted in the male-shaped mould half 3 at about the corresponding locations as the passages 11 for forming and aeration according to the embodiment described above. The ends of said steel nails that face towards the first mould half 1 are brought to project into the space between the mould halves 1, 3 that will be filled by the liquid metal alloy, said steel nails will be cast integral with the portion constituting a metal alloy. It is not possible to bend the steel nails but in order to increase the adhesion against the concrete that forms the concrete block 23 of the paving stone according to the invention the steel nails may be equipped with flanges/barbs. Further, the steel nails may preferably be oriented in a non-perpendicular angle relative to the main plane of the portion 18 constituting a metal alloy and the steel nails are also preferably not parallel to each other. In this case the steel nails are preferably not conical but has a substantially uniform cross-section along their entire length.

According to the embodiment described above the anchoring means in the shape of pins 22 are located along the edges of the portion 18 constituting a metal alloy. However, within the scope of the invention it is also feasible that the anchoring means, regardless if they constitute pins 22 or steel nails, are located in an alternative way on the portion 18 that constitutes a metal alloy. Thus, the anchoring means may for instance have a more central location on the portion 18 constituting a metal alloy.

In the description above it is stated that so-called foundry sand is used to create the mould halves 1, 3, which at present seems to be the most simple and cheapest way to provide casting of a metal alloy, preferably bronze, preferably based on handicraft. However, within the scope of the present invention it is also feasible to use alternative materials in order to achieve a suitable mould for casting of a metal alloy.

As regards the choice of metal alloy it is preferred to use bronze since it has turned out to be suitable for the pending area of use, especially as regards hardness and wear resistance. Alternative metal alloys may be used within the scope of the invention. However, the metal alloy should not be copper based. As a non-limiting example brass may be mentioned as a feasible alternative.

According to the embodiment described above the passages 11 for forming and aeration are through going, i.e. they emerge on the side of the male-shaped mould half 3 that faces away from the male-shaped portions 13. However, within the scope of the present invention it is also feasible that the passages only constitute forming passages for the pins 22, i.e. said passages are not through going but end inside the male-shaped mould half 3.

It is of course not necessary that the paving stone according to the present invention is square, the primary alternative being a rectangular shape although it should be emphasised that a number of different shapes are feasible within the scope of the invention.

According to the embodiment described above the recesses 21 are in the shape of four-sided, truncated cones. However, within the scope of the invention it is feasible that the recesses have other shapes. As a non-limiting example a circular cone may be mentioned. Generally, it is important that the shape of the recesses facilitates the relief vis-á-vis the prototype in connection with the finishing of the male-shaped mould half 3 and that dynamic forces from the traffic are carried in a satisfying way.

1. Method for manufacturing a paving stone, c h a r a c t e r i z e d in that in a first step a first mould (1, 3) is set up, said mould (1, 3) having an internal space for casting a first portion (18) of the paving stone, said first portion (18) constituting a metal alloy, and that in a second step the metal alloy, in liquid state, is supplied to the space inside the first mould, that in connection with casting of the first portion (18) anchoring means, in the shape of elongated elements (22), are attached to said first portion (18), said elongated elements (22) having a general extension transverse to the main plane of the first portion (18), and that in a third step, in a second mould, the first portion (18) is cast integral with a volume of concrete that in hardened state forms a second portion (23) of the paving stone on the side of the first portion (18) where the anchoring means are located, said second portion constituting a concrete block (23).

2. Method according to claim 1, c h a r a c t e r i z e d in that the anchoring means constitute pins (22) that are cast from the liquid metal alloy in cavities (11) in the first mould (1, 3) in connection with casting of the first portion (18), said pins (22) and the first portion (18) being integral.

3. Method according to claim 2, c h a r a c t e r i z e d in that the pins (22) are bent before the first portion (18) is cast integral with the concrete.

4. Method according to any of the previous claims, c h a r a c t e r i z e d in that the first mould that includes two mould halves (1, 3) is set up from foundry sand that in connection with the setting up is given a suitable humidity.

5. Paving stone comprising a first portion (18) and a second portion (23) in the shape of a concrete block, said second portion (23) being cast integral with the first portion, said first portion (18) constituting a metal alloy, and that the first portion (18) is equipped with anchoring means (22) having an extension transverse to the main plane of the first portion (18), said anchoring means (22) being cast integral with the first portion (18), c h a r a c t e r i z e d in that the adhesion surface of the first portion (18), said adhesion surface abutting the concrete, is equipped with conical recesses (21).

6. Paving stone according to claim 5, c h a r a c t e r i z e d in that the recesses (21) are in the shape of truncated cones that define surfaces (21a) at different angles relative to each other.

7. Paving stone according to claim 5 or 6, c h a r a c t e r i z e d in that the anchoring means are located along the edges of the first portion (18).

8. Paving stone according to any of the claims 5-7, c h a r a c t e r i z e d in that the anchoring means constitute pins (22) of the metal alloy that the first portion (18) is created from, and that said pins (22) are integral with said first portion (18).

9. Paving stone according to claim 8, c h a r a c t e r i z e d in that the pins (22) are bent.

10. Paving stone according to any of the claims 5-9, c h a r a c t e r i z e d in that the first portion (18) has a rough surface on the side that faces away from the second portion (23).

11. Paving stone according to any of claims 5-7, c h a r a c t e r i z e d in that the anchoring means constitute nails of iron based material, said nails being cast integral with the first portion (18).
